(19) United States
(12) Patent Application Publication
(10) Pub. No.: US 2026/0214294 A1
(43) Pub. Date: Jul. 23, 2026

(54) METHOD, APPARATUS, DEVICE, STORAGE MEDIUM AND PROGRAM PRODUCT FOR MEDIA EDITING

(71) Applicant: Beijing Zitiao Network Technology Co., Ltd., Beijing (CN)

(72) Inventor: Honghao ZENG, Beijing (CN)

(21) Appl. No.: 19/392,096

(22) Filed: Nov. 17, 2025

(30) Foreign Application Priority Data
Nov. 18, 2024 (CN) 202411652923.5

(51) Int. Cl. H04N 21/431; H04N 21/854

(52) U.S. Cl. CPC H04N 21/4318; H04N 21/854

(57) ABSTRACT

Embodiments of the disclosure provide a method, an apparatus, a device, a storage medium and a program product for media editing. The method includes: presenting an editing interface of media content, the editing interface including at least a first track, and the first track corresponding to at least one media segment of the media content; determining, in response to receiving an editing operation for the first media segment of the at l east one media segment, a second track associated with the first media segment, the second track indicating a media resource applied to the target range of the first media segment; and adjusting, based on the editing operation, a first position of the first media segment in the first track and a second position of the media resource in the second track, such that the media resource is applied to the target portion reserved in the target range.

### CROSS-REFERENCE

The present application claims priority to Chinese Patent Application No. 202411652923.5, filed on Nov. 18, 2024 and entitled “METHOD, APPARATUS, DEVICE, STORAGE MEDIUM AND PROGRAM PRODUCT FOR MEDIA EDITING”, the entirety of which is incorporated herein by reference.

### FIELD

Example embodiments of the disclosure generally relate to the field of computers, and in particular, to a method, an apparatus, a device, a computer-readable storage medium, and computer program product of editing media.

### BACKGROUND

With the development of computer technologies, more and more users create and share media content through an Internet platform. During a creation process of media content, various types of media resources (e.g., effects, filters, video animations, subtitles, pictures) and the like may assist users in creating richer media content, thereby improving a creation effect of the media content.

### SUMMARY

In a first aspect of the disclosure, a method of media editing is provided. The method includes: presenting an editing interface of media content, the editing interface comprising at least a first track, and the first track corresponding to at least one media segment of the media content; determining, in response to receiving an editing operation for a first media segment of the at least one media segment, a second track associated with the first media segment, the second track indicating a media resource applied to a target range of the first media segment; and adjusting a first position of the first media segment in the first track and a second position of the media resource in the second track based on the editing operation, so such that the media resource is applied to a reserved target portion part reserved in the target range.

In a second aspect of the disclosure, an apparatus for media editing is provided. The apparatus includes: a presenting module configured to present an editing interface of media content, the editing interface comprising at least a first track, and the first track corresponding to at least one media segment of the media content; a determining module configured to determine, in response to receiving an editing operation for a first media segment in the at least one media segment, a second track associated with the first media segment, the second track indicating a media resource applied to a target range of the first media segment; and an adjusting module configured to adjust a first position of the first media segment in the first track and a second position of the media resource in the second track based on the editing operation, such that the media resource is applied to a target portion reserved in the target range.

In a third aspect of the disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the disclosure, a computer-readable storage medium is provided. The computer-readable storage medium stores a computer program, and the computer program is executable by the processor to implement the method of the first aspect.

In a fifth aspect of the disclosure, a computer program product is provided. The computer program product includes computer-executable instructions that, when executed by a processor, implement the method of the first aspect.

It should be understood that the content described in this summary section is not intended to limit the key features or major features of the embodiments of the disclosure, nor is it intended to limit the scope of the present disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure can be implemented;

FIG. 2A to FIG. 2D illustrate schematic diagrams of an interaction interface according to some embodiments of the disclosure;

FIG. 3A to FIG. 3B illustrate schematic diagrams of a track display area according to some embodiments of the disclosure;

FIG. 4A to FIG. 4C illustrate schematic diagrams of another track display area according to some embodiments of the disclosure;

FIG. 5 illustrates a flowchart of a media editing process according to some embodiments of the disclosure;

FIG. 6 illustrates a schematic structural block diagram of an apparatus for media editing according to some embodiments of the disclosure; and

FIG. 7 illustrates a block diagram of an electronic device capable of implementing various embodiments of the disclosure.

### DETAILED DESCRIPTION

Embodiments of the disclosure will be described in more detail below with reference to the accompanying drawings. Although certain embodiments of the disclosure are shown in the accompanying drawings, it should be understood that the disclosure may be implemented in various forms, and should not be construed as being limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the descriptions of the embodiments of the disclosure, the terms “including” and the like should be understood as open-ended inclusion, i.e., “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may involve in data of a user, acquisition and/or use of data, and the like. These aspects all follow the corresponding laws and regulations and related provisions. In the embodiments of the disclosure, the collection, acquisition, processing, refinement, forwarding, usage and the like for all data, are performed on the premise of awareness and confirmation of users. Accordingly, when implementing the embodiments of the disclosure, the types of the data or information, the usage scope, the usage scenario, and the like that may be involved should be notified to the user and obtain the authorization of the user in an appropriate manner according to the relevant laws and regulations. The specific notification and/or authorization manner may vary according to actual situations and application scenarios, and the scope of the disclosure is not limited in this respect.

According to the solutions in the specification and the embodiments, if personal information processing is involved, processing will be performed on the premise of having a legality basis (for example, obtaining consent of a personal information subject, or being necessary for performing a fulfillment contract, etc.), and processing will only within a specified or agreed range. If the user rejects personal information other than necessary information required by the basic function, the basic function of the user will not be affected.

As described above, in general, the electronic device may generate the media content with better creation effect based on the editing operation of the user on the media content in the editing interface and the editing operation on the media resource. For example, the user may select a media resource provided by the electronic device to assist in achieving editing of the media content. It should be understood that the media resource may be used to create digital content, including but not limited to audio, video animation, subtitle, sticker elements, picture-in-picture, effects, and other types of resources.

In some scenarios, a user may perform media editing in an editing interface including multiple tracks, which include, for example, a main track indicating media content, a video animation track indicating a video animation, an audio track indicating audio, and the like. The user may adjust respective tracks to adjust an presence time point and a presence time duration of media content/media resources indicated by each track.

In order to improve the creation effect, the user needs to adjust respective tracks frequently, and such an adjustment manner has a serious negative effect on the editing efficiency of the media content/media resource. Moreover, since the manual operation involves a relatively large error, the probability of problems, such as unreasonable rhythm and poor picture effect quality, is also increased.

Therefore, the conventional technology still faces a large challenge in editing efficiency and accuracy of editing media content.

In view of this, embodiments of the disclosure provide a solution of media editing. According to the solution, an editing interface of the media content may be presented. The editing interface includes at least a first track, and the first track corresponds to at least one media segment of the media content. Furthermore, a second track associated with the first media segment may be determined in response to receiving an editing operation for the first media segment in the at least one media segment. The second track indicates a media resource that is applied to the target range of the first media segment. Still further, the first position of the first media segment in the first track and the second position of the media resource in the second track may be adjusted based on the editing operation, such that the media resource is applied to the target portion reserved in the target range.

In this way, embodiments of the disclosure enable determination of the second track associated with the first media segment in the media editing process in response to receiving the editing operation for the first media segment in the first track, and adjust the first position of the first media segment in the first track and the second position in the media resource second track applied by the first media segment. This improves the accuracy of the linkage relationship between the first position and the second position, and greatly improve the editing efficiency of the media content by adjusting two tracks based on one single editing operation.

Therefore, the embodiment of the disclosure can achieve the adjustment of the first track and the second track based on an editing operation, such that the editing accuracy and the editing efficiency of the media content are improved.

### Example Environment

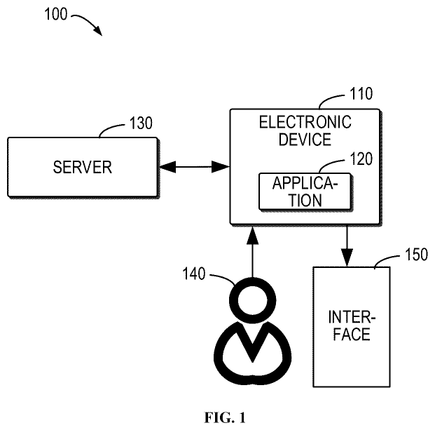

FIG. 1 illustrates a schematic diagram of an example environment 100 in which embodiments of the disclosure may be implemented. As shown in FIG. 1, the example environment 100 may include an electronic device 110.

In the example environment 100, an application 120 is installed in the electronic device 110. The user 140 may interact with the application 120 via the electronic device 110 and/or its attachment device. The application 120 may be an application that supports editing media content, for example, a video clip application, or any other suitable application.

In the environment 100 of FIG. 1, if the application 120 is in an active state, the application 120 may provide a presentation interface 150 for the user 140.

In some embodiments, the electronic device 110 communicates with the server 130 to enable the supply of services to the application 120. The electronic device 110 may be of any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.) .

The server 130 may be a standalone physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support content presentation in the electronic device 110.

A communication connection may be established between the server 130 and the electronic device 110. The communication connection may be established in a wired manner or a wireless manner. The communication connection may include, but are not limited to, a Bluetooth connection, a mobile network connection, a universal serial bus connection, a wireless fidelity connection, and so on, and embodiments of the disclosure are not limited in this respect. In an embodiment of the disclosure, the server 130 and the electronic device 110 may implement signaling interaction through a communication connection between the server 130 and the electronic device 110.

It should be understood that the structures and functions of the various elements in the environment 100 are described for example purposes only and do not suggest any limitation to the scope of the disclosure.

Some example embodiments of the disclosure will be described below with continued reference to the accompanying drawings.

### Example Interaction

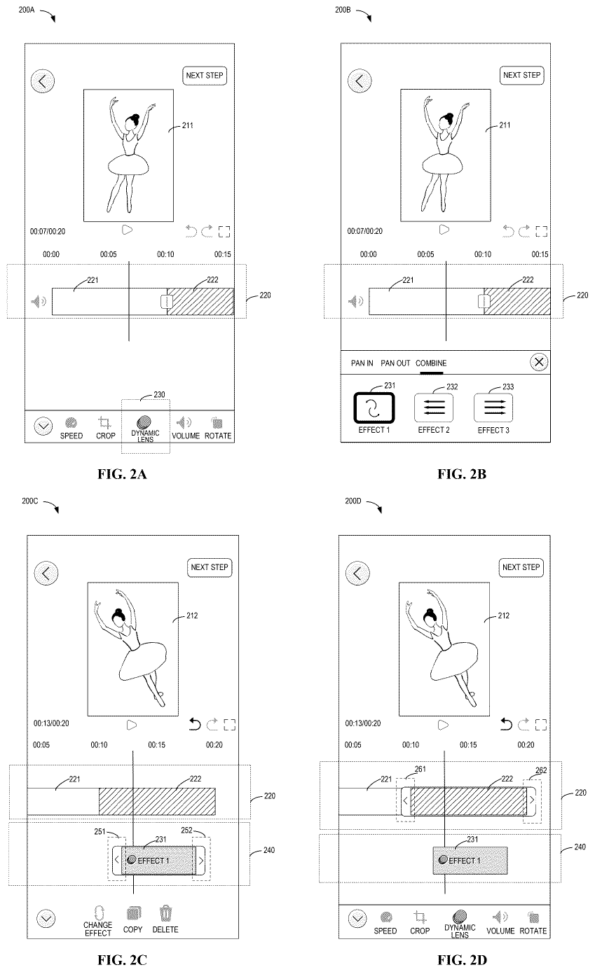

An example interaction process according to embodiments of the disclosure will be described below with reference to FIGS. 2A-2D. FIGS. 2A-2D illustrate example interaction interfaces 200A to 200D, respectively, which may be provided, for example, by electronic device 110 shown in FIG. 1, in accordance with some embodiments of the disclosure.

As shown in FIG. 2A, the electronic device 110 may, for example, present an interaction interface 200A (an editing interface of media content), and for ease of comprehension, the disclosure takes a video as media content and a video animation as a media resource.

Based on this, the interaction interface 200A may present a preview area 211 of the video. The preview area 211 displays, for example, a video uploaded by a user, a video selected from a video material, a video obtained by editing a video material, and the like. The interactive interface 200A may also present an editing track of the video, i.e. a first track 220. For example, the first track includes at least a video segment 221 and a media segment 222. The electronic device 110 may check each media segment corresponding to the first track based on a sliding operation performed by the user for the first track.

The interaction interface 200A may also include one or more control to edit at least one media segment in the first track. For example, the interaction interface 200A may include control that indicate “speed”, “crop”, “dynamic lens”, “volume”, “rotate” or the like, or other implementable controls, such as a control indicating “color adjustment”, a control indicating “filters” and so forth.

In some embodiments, in response to a trigger operation of the user for a control 230 (indicating “dynamic lens”), the electronic device 110 may display a plurality of video animations for selection by the user. For example, the electronic device displays a video animation 231 (effect 1, indicating rotation of a video picture), a video animation 232 (effect 2, indicating shifting the video picture to the left), an effect 233 (effect 3, indicating shifting the video picture to the right) as shown in FIG. 2B. Such a video animation may be provided by the application 120, or may be imported or otherwise obtained by the user in an appropriate manner.

In some embodiments, the electronic device 110 may apply a corresponding video animation effect in the video in response to a trigger operation of the user for any video animation. For example, the user may select the video animation 231, and the electronic device may apply a video animation effect (rotation on a video picture) corresponding to the video animation 231 in the video.

In some embodiments, the electronic device 110 may present a track, i.e., a second track, indicating a video animation. For example, the track indicating the video animation may be a track 240 in which video animation 231 may be indicated, in interactive interface 200C. The electronic device may receive an editing operation for the video animation 231, and edit a range of the video to which the video animation is applied.

As some examples, the editing operation for the video animation 231 may be a drag operation (to change a start/start time instant of the video animation 231) for the control 251 in the interaction interface 200C, a drag operation (to change an end/end time instant of the video animation 231) for the control 252 in the interaction interface 200C, a drag operation (to change a range of the video animation 231 in the media content) for the video animation 231, and the like.

It should be understood that the specific media resource described in the foregoing embodiments is merely as an example, and the disclosure is not intended to limit the specific form and the number of specific effects of the media resource.

In some other scenarios, the media resource described above may also be applied in an appropriate environment in other manners. For example, the media resource may be applied to a scenario such as an audio editing application.

In some embodiments, the electronic device 110 may adjust a position, a duration, and the like of the video segment in response to an editing operation for any video segment of the video. Alternatively, the electronic device 110 may adjust the video range applied by the media resource in response to the editing operation for the media resource. In the case of multiple tracks, the electronic device 110 needs to adjust the media content / media resource of each track frequently based on the user operation. In this way, the editing efficiency is low, and the error is large, which results in the low quality of the video edited finally.

Based on this, in some embodiments, the electronic device 110 may determine a second track associated with the first media segment in response to receiving an editing operation for the first media segment in the at least one media segment.

As some examples, as shown in FIG. 2C, the media segment is, for example, the video segment 221, media segment 222. The first media segment is, for example, the media segment 222 described above. The second track is, for example, the track 240 described above, which indicates that the video animation 231 is applied to the target range in the media segment 222. The media resource may include the foregoing video animation, i.e., a video animation effect applied by the user in the media content, and as some example, the video animation includes, but not limited to, left pan effects, right pan effects, screen rotation, zooming, and the like.

In some embodiments, the editing operation may include at least one of: an editing operation for cropping the first media segment; an editing operation for adjusting a playing speed of the first media segment; or an editing operation for adjusting an order of the first media segment in the at least one media segment.

As some examples, the editing operation for cropping the first media segment may be implemented through dragging a start/a start time instant the first media segment(for example, a trigger operation for the control 261 in the interaction interface 200D shown in FIG. 2D), or an end/an end time instant (for example, a trigger operation for the control 262 in the interaction interface 200D shown in FIG. 2D) by the user, or may be implemented by automatically cropping on a duration of first media segment inputted by the user, and the like. The editing operation for adjusting the playing speed of the first media segment is implemented by, for example, the user triggering on the control indicating “speed” in the interactive interface 200A, or by adjusting the playing speed value through the attribute editing interface, and so on. The editing operation for adjusting an order of the first media segment in the at least one media segment may, for example, by dragging the first media segment to change the order of the first media segment in the media content, and so on. The specific implementation of the editing operation is not limited in the disclosure.

Based on this, the user triggers an editing operation for the media segment 222, and the electronic device 110 determines, in response to receiving an editing operation of the media segment 222, a second track associated with the media segment 222, i.e., a media resource indicating a target range applied to the media segment 222.

In some embodiments, the video animation may be shown in 212 as shown in FIG. 2C for viewing by a user. For example, the video animation may indicate a picture rotation effect for the media content as in the preview area 212.

In some embodiments, the electronic device 110 may support creation of richer media content, such that the media content may correspond to a plurality of candidate tracks, for example, a video animation track corresponding to the video segment 221. Based on this, the electronic device 110 may determine, from the plurality of candidate tracks, a second track overlapping the time range of the first media segment, i.e., the electronic device 110 may determine the track indicating the video animation applied to the first media segment as the second track.

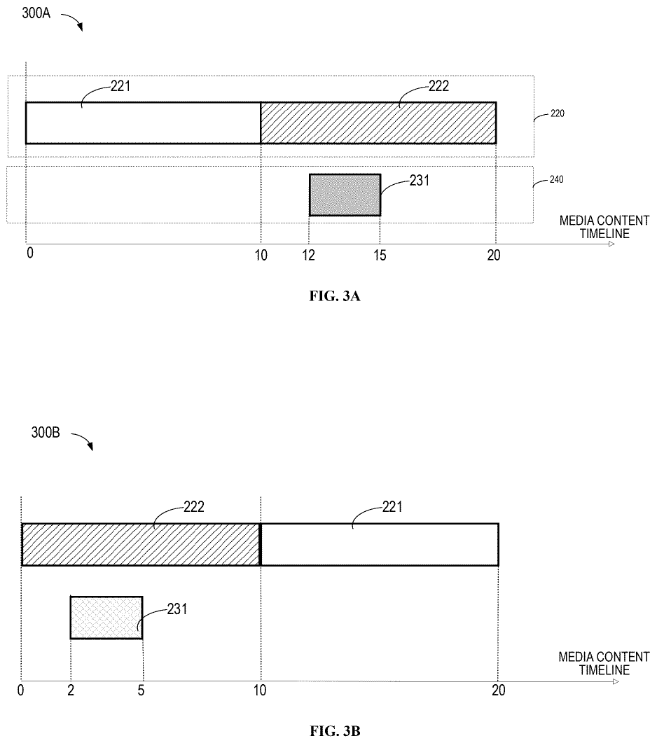

To describe the embodiments of the disclosure more clearly, a schematic diagram of a track display area according to an embodiment of the disclosure is described below with reference to FIGS. 3A to 3B. FIG. 3A to 3B illustrate schematic diagrams of a track display area 300A to a track display area 300B according to some embodiments of the disclosure, where the track 220 and the track 240 of FIGS. 2C to 2D are shown in the track display area 300A to the track display area 300, for example.

As shown in FIG. 3A, the first track and the second track may be time-aligned. The electronic device 110 may determine that the first position of the media segment 222 in the first track is [10, 20], i.e., the media segment 222 is portion of the media content spanning from 10^{th} to 20^{th} seconds. The electronic device 110 may also determine that the position of the media resource in the second track is [12, 15], i.e., the media resource is applied to the media content spanning from 12^{th} to 15^{th} second.

Further, based on the editing operation for the media segment 222, the electronic device may adjust the first position of the media segment 222 in the first track and the second position of the video animation 231 in the second track, such that the video animation 231 may be applied to the target portion reserved in the target range.

Based on this, the electronic device 110 may synchronously adjust the media segment 222 and the video animation 231 based on the editing operation for the media segment 222, reducing the complexity of the operation process of the media editing, and improving the media editing efficiency.

To more accurately adjust the second position of the video animation 231 in the second track, the electronic device 110 may determine adjustment information for the media segment 222 based on the editing operation. Based on the adjustment information, the electronic device 110 may determine a target portion reserved in the target range, such that the second position of the media resource in the second track may be determined based on the global time information of the target portion relative to the media content.

As some examples, the adjustment information includes, but is not limited to, start position adjustment information, duration adjustment information, and the like. For example, the adjustment information may be start position adjustment information of the media segment 222 relative to the media content, start position adjustment information of the media segment 222 relative to the media material (i.e., a source material of the media segment, such as a video uploaded by the user, a material selected by the user from the voxel library, and the like), adjustment information of a duration of the media segment 222, and the like.

The global time information includes, but is not limited to, a start time instant of the target portion relative to the media content, an end time instant of the target portion relative to the media content, and/or a duration of the target portion. The electronic device 110 may determine global time information of the media resource relative to the media content based on the global time information of the target portion relative to the media content. Thus, the electronic device may determine a second position of the media resource in the second track to align the media resource and the target portion on the media content timeline.

In some embodiments, the editing operation includes a first editing operation for adjusting a starting position of the media segment 222, for example, the first editing operation may be used to adjust an order of the media segment 222 in the media content. Based on the first editing operation, the electronic device 110 may adjust the position of the media segment 222 in the first track, and the length of the media segment does not be changed, such that the offset of the target portion to which the video animation is applied may be determined based on the offset of the start position of the media segment.

Taking FIG. 3B as an example, which indicates that the editing operation includes a track display status of a first editing operation for adjusting a start position of the media segment 222. Specifically, the user performs an operation such as dragging on the media segment 222. The electronic device 110 may in response to an editing operation such as a dragging operation by the user on the media segment 222, cause the media segment 222 to be moved to a position of [0, 10] prior to the video segment 221 along the first track by following a dragging direction of the user. Thus, the video animation 231 moves along the second track to the position of [2, 5] as the media segment 222 moves.

The following describes a specific implementation of the electronic device 110 responding to the first editing operation.

In response to the first editing operation of the user for the media segment 222, the electronic device 110 determines that the start offset of the start position of the media segment 222 is −10. Based on the start time instant 12 of the target range in the media content, the electronic device 110 may determine that the first start time instant of the target portion relative to the media content is 12+(−10)=2 after the offset of the media segment 222 occurs. That is, after the offset of the media segment 222 occurs, the first start time instant at which the video animation 231 is applied to the target portion of the media content is 2, and the duration of the target part does not change, i.e., the duration of the target part is 15−12=3. Thus, the electronic device may determine that the video animation 231 is applied to [2, 5] of the media content, i.e., the video animation 231 is applied to the 2^{nd} second to the 5^{th} second of the media content.

In some embodiments, the editing operation may further include a second editing operation for adjusting a segment length of the media segment 222, for example, the second editing operation may be used for adjusting a playing speed of the media segment 222, cropping the media segment 222, and the like. Based on the second editing operation, the electronic device 110 may adjust the duration of the media segment 222 in the first track, and the start position of the media segment 222 relative to the media content may not change.

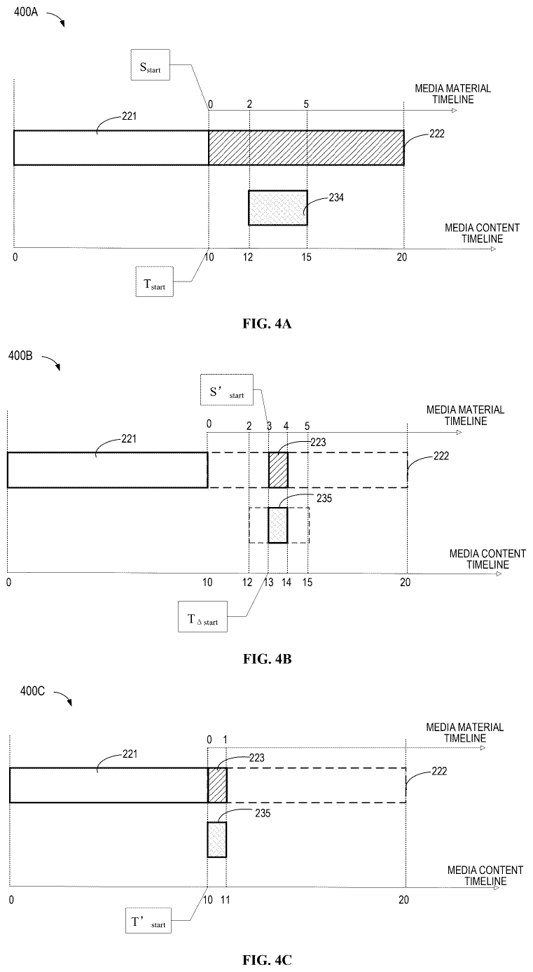

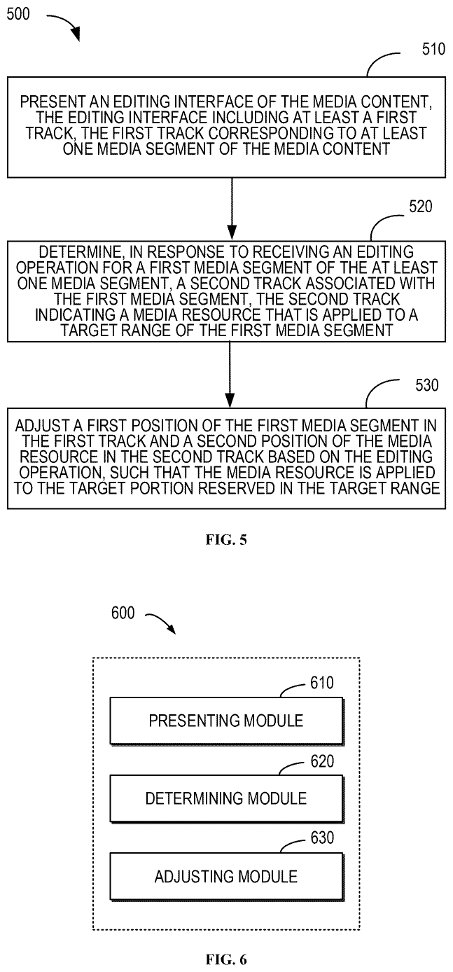

To more accurately describe a specific implementation of the electronic device 110 responding to the second editing operation, another schematic diagram of another track display area according to embodiments of the disclosure will be described below with reference to FIGS. 4A to 4C. FIGS. 4A to 4C illustrate the track display area 400A to the track display area 400C, which for example show the track 220 and the track 240 in FIGS. 2C to 2D, according to some embodiments of the disclosure.

FIG. 4A shows the global time information of the target portion relative to the media content, and the electronic device 110 may refer to the time information of the media segment relative to the media content (as shown by the media content timeline in FIG. 4A) and the time information of the media segment relative to the media content (as shown by the media material timeline in FIG. 4A).

Based on this, the electronic device 110 adjusts the media segment to be the video segment 223 (i.e., the video segment 223 as shown in FIG. 4B) based on the adjustment of the segment length of the media segment 222 by the user. The electronic device 110 adjusts the video animation 231 to be the video animation 235 based on the adjusted video segment 223, to cause the video animation 235 to be applied to the target portion in the adjusted video segment 223. Further, the electronic device 110 aligns the video segment 223 with the video segment 221 and synchronously moves video animation 231, such as the video segment 223 and the video animation 235 as shown in FIG. 4C. Therefore, the electronic device 110 can implement the automatic linkage effect of the video segment and the video animation.

The specific implementation of the electronic device 110 responding to the second editing operation will be further described below with reference to FIGS. 4A to 4C.

As shown in FIG. 4A, a placement interval of the media segment 222 in the media content is (Tₛₜₐᵣₜ, T_{duration})=(10, 10), i.e., the first time information of the first position on the first track is (Tₛₜₐᵣₜ, T_{duration})=(10, 10). Similarly, a selected interval of the media segment 222 in the media material is (Sₛₜₐᵣₜ, S_{duration})=(0, 10).

Taking the video animation 231 applied to the 2^{nd} to 5^{th} seconds of the media segment 222 as an example, the placement interval of the target range applied by the video animation 231 is (Aₛₜₐᵣₜ, A_{duration}) [12, 3], i.e., the video animation 231 is applied to the range of the 12^{th} second to the 15^{th} second of the media content.

As some examples, the user crops the media segment 222 such that the start position of the media segment is right shifted by 3 and the end position of the media segment 222 is left shifted by 6. As shown in FIG. 4B, based on the cropping operation by the user, the electronic device 110 may obtain the video segment 223. Thus, the selected interval of the cropped video segment 223 relative to the media material is (S′ₛₜₐᵣₜ, S′_{duration})=(3, 1).

As some examples, the selected interval of the adjusted video segment 223 relative to the media material may be obtained by detecting the change of the video segment 223 by the detection tool, or be obtained in other suitable manners, which is not limited in the embodiments of the disclosure.

Further, the electronic device 110 may determine the offset (i.e., the second start offset) S_{Δstart}=S′ₛₜₐᵣₜ−Sₛₜₐᵣₜ=3 of the media segment in the media material, based on the selected interval of the video segment 221 relative to the media material and the change of the video segment 223 relative to the selected interval of the media material. Similarly, the electronic device may determine the duration change S_{Δduration}=S′_{duration}−S_{duration}=−9 of the selected interval between the video segment 223 and the video segment 223.

Therefore, based on the second start offset S_{Δstart} of the media segment, the duration change S_{Δduration} of the selected interval between the video segment 223 and the video segment 223, and the placement interval (Tₛₜₐᵣₜ, T_{duration}) of the media segment in the first track, the electronic device 110 may determine the placement interval[T_{Δstart},T_{Δend}]=[Tₛₜₐᵣₜ+S_{Δstart},Tₛₜₐᵣₜ+T_{duration}+S_{Δduration}]=[13,14] of the target portion (for example, the video segment 223) reserved in the video segment 221. That is, the first time interval reserved in the first media segment is [T_{Δstart},T_{Δend}]=[13, 14].

To ensure that the video animation 231 is applied to the target portion reserved in the first media segment, the electronic device 110 takes the intersection of the placement interval [T_{Δstart},T_{Δend}] of the target portion reserved in the video segment 221 and the placement interval (i.e., the second time interval of the target range, [Aₛₜₐᵣₜ,A_{end}]) of the video animation 231 to obtain the intersection range [A′ₛₜₐᵣₜ, A′_{end}]=[13, 14]. As shown in FIG. 4B, after the linked adjustment, the video animation 231 is applied to the 13^{th} to 14^{th} seconds in the media content, i.e., the video animation 235.

Further, to ensure consistency of the media content, the electronic device 110 may connect the cropped video segment 223 with the video segment 221. As shown in FIG. 4C, based on the placement interval [10, 20] of the video segment 221 in the first track, the start time instant of the placement interval of the cropped video segment 223 may be adjusted to 10.

Specifically, the electronic device 110 may determine that the adjusted placement interval of the video segment 223 relative to the media content is (T′ₛₜₐᵣₜ, T′_{duration})=(10, 1).

As some examples, the placement interval of the adjusted video segment 223 relative to the media content may be obtained by detecting the change of the video segment 223 by the detection tool, or be obtained in other suitable manners, which is not limited in the embodiments of the disclosure.

To ensure that the video animation 235 is applied to the adjusted video segment 223, i.e., the video animation 235 is applied the 10^{th} second to the 11^{th} second of the media content, the electronic device 110 may determine the final position of the video animation in the second track based on the change of the video segment.

Based on this, the electronic device 110 may determine the relative value of the placement time A″ₛₜₐᵣₜ before the adjustment of the video animation relative to the media segment, for example, the relative value of the start of the media segment 223 and the video animation 235 as shown in FIG. 4B.

To reduce the detection cost for detecting the relative value A″ₛₜₐᵣₜ of the placement time before the adjustment of the video animation relative to the media segment, the electronic device 110 may determine the relative value A″ₛₜₐᵣₜ of the start of the media segment 223 and the video animation 235 based on the start time A′ₛₜₐᵣₜ of the intersection range, the start time Tₛₜₐᵣₜ of the media segment 222 in the placement interval of the media content, and the start time T_{Δstart} of the target portion reserved in the video segment 221 in the placement interval. That is, A″ₛₜₐᵣₜ=A′ₛₜₐᵣₜ−Tₛₜₐᵣₜ-T_{Δstart}=0.

Further, based on the relative value of the start of the media segment 223 and the video animation 235 and the start time instant of the adjusted video segment 223 relative to the placement interval of the media content, the electronic device 110 may determine a final start time instant (a second start time instant of the target portion relative to the media content) of the video animation 235 to be 10, and determine a final duration (a time length of the target portion) of the video animation 235 to be 1 based on the length of the intersection range [A′ₛₜₐᵣₜ, A′_{end}].

Thus, the electronic device 110 may determine that the global time information of the target portion relative to the media content is (10, 1), i.e., the video animation 235 is applied to the 10^{th} second to the 11^{th} second of the media content. As shown in FIG. 4C, the final video segment 223 is placed on the first track from the 10^{th} second to 11^{th} second, and the video animation 235 is placed on the second track from the 10^{th} second to 11^{th} second.

It should be understood that the foregoing specific values and specific parameter representations are merely for ease of understanding, and cannot be understood as limiting the disclosure.

As some examples, the editing operation may include a first editing operation for adjusting a start position of the media segment 222, or the editing operation may further include a second editing operation for adjusting a segment length of the media segment 222, or the editing operation may further include other implementable editing operations, such as a third editing operation including a first editing operation and a second editing operation, and the like. It should be understood that the disclosure is described for instance by using an example in which the editing operation includes the first editing operation or the second editing operation, and for the case of other editing operations, reference may be made to the embodiments of the disclosure. For example, after the media segment 222 and the media resource are adjusted based on the first editing operation, the media segment 222 and the media resource are adjusted again based on the second editing operation, or after the media segment 222 and the media resource are adjusted based on the second editing operation, the media segment 222 and the media resource are adjusted again based on the first editing operation, which is not limited in the embodiments of the disclosure.

Based on such a way, the embodiments of the disclosure can determine, in response to receiving the editing operation for the first media segment in the first track, the second track associated with the first media segment in the media editing process, and adjust the first position of the first media segment in the first track and the second position of the media resource applied by the first media segment in the second track. This improves the accuracy of the linkage relationship between the first position and the second position, and achieves the adjustment of the two tracks based on one editing operation, greatly improving the editing efficiency of the media content.

Therefore, the embodiments of the disclosure can achieve the adjustment of the first track and the second track based on the editing operation, such that the editing accuracy and the editing efficiency of the media content are improved.

### Example Processes

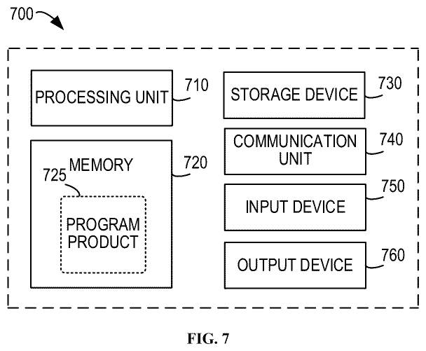

FIG. 5 illustrates a flowchart of an example process 500 of media editing according to some embodiments of the disclosure. The process 500 may be implemented at electronic device 110. The process 500 is described below with reference to FIG. 1.

At block 510, the electronic device 110 presents an editing interface of the media content, the editing interface including at least a first track, the first track corresponding to at least one media segment of the media content.

At block 520, the electronic device 110 determines, in response to receiving an editing operation for a first media segment of the at least one media segment, a second track associated with the first media segment. The second track indicates a media resource that is applied to a target range of the first media segment.

At block 530, the electronic device 110 adjusts a first position of the first media segment in the first track and a second position of the media resource in the second track based on the editing operation, such that the media resource is applied to the target portion reserved in the target range.

In some embodiments, adjusting the second position of the media resource in the second track based on the editing operation includes: determining, based on the editing operation, adjustment information for the first media fragment; determining, based on the adjustment information, a target portion reserved in the target range; and determining, based on the global time information of the target portion relative to the media content, a second position of the media resource in the second track.

In some embodiments, the editing operation includes a first editing operation for adjusting a start position of the first media segment, and the process 500 further includes: determining a first start time instant of th target portion relative to the media content based on a start offset corresponding to the start position and a start time instant of the target range in the media content; and determining, based on the first start time instant, global time information of the target portion relative to the media content.

In some embodiments, the editing operation includes a second editing operation for adjusting a segment length of the first media segment, and the process 500 further includes: determining, based on the second editing operation, a second start time instant of the target portion relative to the media content and a time length of the target portion; and determining, based on the second start time instant and the time length of the target portion, global time information of the target portion relative to the media content.

In some embodiments, determining the second start time instant of the target portion relative to the media content based on the second editing operation includes: determining a first time interval reserved in the first media segment based on the adjustment information and the first time information of the first position in the first track; and determining a second start time instant of the target portion relative to the media content based on an intersection range of the first time interval and the second time interval of the target range.

In some embodiments, determining the second start time instant of the target portion relative to the media content based on the intersection range of the first time interval and the second time interval of the target range includes: determining the second start time instant of the target portion relative to the media content based on a third start time instant of the intersection range and a first start offset of the first time interval relative to the first media segment.

In some embodiments, the determining the first time interval of the first media segment based on the adjustment information and the first time information of the first position includes: determining, based on the adjustment information, a second start offset of the first media segment in a corresponding media material; and determining, based on the second start offset and the first time information, the first time interval of the first media segment.

In some embodiments, determining the second track associated with the first media segment includes determining, from the plurality of candidate tracks, the second track overlapping the time range of the first media segment.

In some embodiments, the editing operation includes at least one of: an editing operation for cropping the first media segment; an editing operation for adjusting a playing speed of the first media segment; an editing operation for adjusting an order of the first media segment in the at least one media segment.

In some embodiments, the at least one media resource comprises a video animation.

### Example Apparatus and Device

Embodiments of the disclosure also provide a corresponding apparatus for implementing the above method or process. FIG. 6 shows a schematic structural block diagram of an apparatus 600 for media editing according to some embodiments of the disclosure. The apparatus 600 may be implemented as or included in the electronic device 110 as discussed above. The various modules/components in the apparatus 600 may be implemented by hardware, software, firmware, or any combination thereof.

As shown in FIG. 6, the apparatus 600 includes a presenting module 610, configured to present an editing interface of media content, the editing interface including at least a first track, and the first track corresponding to at least one media segment of the media content; a determining module 620, configured to determine, in response to receiving an editing operation for a first media segment in the at least one media segment, a second track associated with the first media segment, the second track indicating a media resource applied to a target range of the first media segment; and an adjusting module 630, configured to adjust a first position of the first media segment in the first track and a second position of the media resource in the second track based on the editing operation, such that the media resource is applied to a target portion reserved in the target range.

In some embodiments, the adjusting module 630 is further configured to: determine, based on the editing operation, adjustment information for the first media segment; determine, based on the adjustment information, a target portion reserved in the target range; and determine, based on the global time information of the target portion relative to the media content, the second position of the media resource in the second track.

In some embodiments, the editing operation includes a first editing operation for adjusting a start position of the first media segment, and the apparatus 600 further includes a first information determining module configured to: determine a first start time instant of the target portion relative to the media content based on a start offset corresponding to the start position and a start time instant of the target range within the media content; and determine, based on the first start time instant, the global time information of the target portion relative to the media content.

In some embodiments, the editing operation includes a second editing operation for adjusting a segment length of the first media segment, and the apparatus 600 further includes a second information determining module configured to: determine, based on the second editing operation, a second start time instant of the target portion relative to the media content and a time length of the target portion; and determine, based on the second start time instant and the time length of the target portion, the global time information of the target portion relative to the media content.

In some embodiments, the second information determining module is further configured to: determine a first time interval reserved in the first media segment based on the adjustment information and first time information of the first position in the first track; and determine the second start time instant of the target portion relative to the media content based on an intersection range of the first time interval and a second time interval of the target range.

In some embodiments, the second information determining module is further configured to: determine the second start time instant of the target portion relative to the media content based on a third start time instant of the intersection range and a first start offset of the first time interval relative to the first media segment.

In some embodiments, the second information determining module is further configured to: determine based on the adjustment information, a second start offset of the first media segment in the corresponding media material; and determine, based on the second start offset and the first time information, the first time interval of the first media segment.

In some embodiments, the determining module 620 is further configured to: determine, from a plurality of candidate tracks, a second track overlapping a time range of the first media segment.

In some embodiments, the editing operation includes at least one of: an editing operation for cropping the first media segment; an editing operation for adjusting a playing speed of the first media segment; or an editing operation for adjusting an order of the first media segment in the at least one media segment.

In some embodiments, the at least one media resource includes a video animation.

The units included in the apparatus 600 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 600 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), or the like.

FIG. 7 illustrates a block diagram of an electronic device 700 in which one or more embodiments of the disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the electronic device 110 in FIG. 1 or the apparatus 700 of FIG. 6.

As shown in FIG. 7, the electronic device 700 is in the form of a general-purpose electronic device. Components of the electronic device 700 may include, but are not limited to, one or more processors 710 or processing units, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, a plurality of processors execute computer-executable instructions in parallel to improve the parallel processing capability of the electronic device 700.

The electronic device 700 generally includes a plurality of computer storage media. Such media may be any available media accessible to the electronic device 700, including, but not limited to, volatile and non-volatile media, removable and non-removable media. The memory 720 may be a volatile memory (e.g., a register, a cache, a random access memory (RAM)), a non-volatile memory (e.g., a read-only memory (ROM), electrically erasable programmable read-only memory (EEPROM), a flash memory), or some combination thereof. The storage device 730 may be a removable or non-removable medium and may include a machine-readable medium, such as a flash drive, magnetic disk, or any other medium, which may be capable of storing information and / or data and may be accessed within the electronic device 700.

The electronic device 700 may further include additional removable/non-removable, volatile/non-volatile storage media/medium. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the disclosure.

The communication unit 740 implements communication with other electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, the external device such as a storage device, a display device, etc., communicates with one or more devices that enable a user to interact with the electronic device 700, or communicates with any device (e.g., a network card, a modem, etc.) that enables the electronic device 700 to communicate with one or more other electronic devices. Such communication may be performed via an input/output (I/O) interface (not shown).

According to example implementations of the disclosure, there is provided a computer-readable storage medium having computer-executable instructions stored thereon, and the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowchart and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of media editing, comprising:
presenting an editing interface of media content, the editing interface comprising at least a first track, and the first track corresponding to at least one media segment of the media content;
determining, in response to receiving an editing operation for a first media segment of the at least one media segment, a second track associated with the first media segment, the second track indicating a media resource applied to a target range of the first media segment; and
adjusting a first position of the first media segment in the first track and a second position of the media resource in the second track based on the editing operation, such that the media resource is applied to a target portion reserved in the target range.

2. The method of claim 1, wherein adjusting the second position of the media resource in the second track based on the editing operation comprises:
determining, based on the editing operation, adjustment information for the first media segment;
determining, based on the adjustment information, the target portion reserved in the target range; and
determining, based on global time information of the target portion relative to the media content, the second position of the media resource in the second track.

3. The method of claim 2, wherein the editing operation comprises a first editing operation for adjusting a start position of the first media segment, and the method further comprises:
determining a first start time instant of the target portion relative to the media content based on a start offset corresponding to the start position and a start time instant of the target range within the media content; and
determining, based on the first start time instant, the global time information of the target portion relative to the media content.

4. The method of claim 2, wherein the editing operation comprises a second editing operation for adjusting a segment length of the first media segment, and the method further comprises:
determining, based on the second editing operation, a second start time instant of the target portion relative to the media content and a time length of the target portion; and
determining, based on the second start time instant and the time length of the target portion, the global time information of the target portion relative to the media content.

5. The method of claim 4, wherein determining the second start time instant of the target portion relative to the media content based on the second editing operation comprises:
determining a first time interval reserved in the first media segment based on the adjustment information and first time information of the first postion in the first track; and
determining the second start time instant of the target portion relative to the media content based on an intersection range of the first time interval and a second time interval of the target range.

6. The method of claim 5, wherein determining the second start time instant of the target portion relative to the media content based on an intersection range of the first time interval and a second time interval of the target range comprises:
determining the second start time instant of the target portion relative to the media content based on a third start time instant of the intersection range and a first start offset of the first time interval relative to the first media segment.

7. The method of claim 6, wherein determining the first time interval of the first media segment based on the adjustment information and the first time information of the first position comprises:
determining, based on the adjustment information, a second start offset of the first media segment in a corresponding media material; and
determining, based on the second start offset and the first time information, the first time interval of the first media segment.

8. The method of claim 1, wherein determining the second track associated with the first media segment comprises:
determining, from a plurality of candidate tracks, the second track overlapping a time range of the first media segment.

9. The method of claim 1, wherein the editing operation comprises at least one of the following:
an editing operation for cropping the first media segment;
an editing operation for adjusting a playing speed of the first media segment;
an editing operation for adjusting an order of the first media segment in the at least one media segment.

10. The method of claim 1, wherein the at least one media resource comprises a video animation.

11. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
presenting an editing interface of media content, the editing interface comprising at least a first track, and the first track corresponding to at least one media segment of the media content;
determining, in response to receiving an editing operation for a first media segment of the at least one media segment, a second track associated with the first media segment, the second track indicating a media resource applied to a target range of the first media segment; and
adjusting a first position of the first media segment in the first track and a second position of the media resource in the second track based on the editing operation, such that the media resource is applied to a target portion reserved in the target range.

12. The device of claim 11, wherein adjusting the second position of the media resource in the second track based on the editing operation comprises:
determining, based on the editing operation, adjustment information for the first media segment;
determining, based on the adjustment information, the target portion reserved in the target range; and
determining, based on global time information of the target portion relative to the media content, the second position of the media resource in the second track.

13. The device of claim 12, wherein the editing operation comprises a first editing operation for adjusting a start position of the first media segment, and the acts further comprise:
determining a first start time instant of the target portion relative to the media content based on a start offset corresponding to the start position and a start time instant of the target range within the media content; and
determining, based on the first start time instant, the global time information of the target portion relative to the media content.

14. The device of claim 12, wherein the editing operation comprises a second editing operation for adjusting a segment length of the first media segment, and the acts further comprise:
determining, based on the second editing operation, a second start time instant of the target portion relative to the media content and a time length of the target portion; and
determining, based on the second start time instant and the time length of the target portion, the global time information of the target portion relative to the media content.

15. The device of claim 14, wherein determining the second start time instant of the target portion relative to the media content based on the second editing operation comprises:
determining a first time interval reserved in the first media segment based on the adjustment information and first time information of the first postion in the first track; and
determining the second start time instant of the target portion relative to the media content based on an intersection range of the first time interval and a second time interval of the target range.

16. The device of claim 15, wherein determining the second start time instant of the target portion relative to the media content based on an intersection range of the first time interval and a second time interval of the target range comprises:
determining the second start time instant of the target portion relative to the media content based on a third start time instant of the intersection range and a first start offset of the first time interval relative to the first media segment.

17. The device of claim 16, wherein determining the first time interval of the first media segment based on the adjustment information and the first time information of the first position comprises:
determining, based on the adjustment information, a second start offset of the first media segment in a corresponding media material; and
determining, based on the second start offset and the first time information, the first time interval of the first media segment.

18. The device of claim 11, wherein determining the second track associated with the first media segment comprises:
determining, from a plurality of candidate tracks, the second track overlapping a time range of the first media segment.

19. The device of claim 11, wherein the editing operation comprises at least one of the following:
an editing operation for cropping the first media segment;
an editing operation for adjusting a playing speed of the first media segment;
an editing operation for adjusting an order of the first media segment in the at least one media segment.

20. A non-transitory computer-readable storage medium having computer programs stored thereon which, when executed by a processor, implement acts comprising:
presenting an editing interface of media content, the editing interface comprising at least a first track, and the first track corresponding to at least one media segment of the media content;
determining, in response to receiving an editing operation for a first media segment of the at least one media segment, a second track associated with the first media segment, the second track indicating a media resource applied to a target range of the first media segment; and
adjusting a first position of the first media segment in the first track and a second position of the media resource in the second track based on the editing operation, such that the media resource is applied to a target portion reserved in the target range.
